(19) United States
(12) Patent Application Publication
(10) Pub. No.: US 2004/0172649 A1
(43) Pub. Date: Sep. 2, 2004

(54) Method and device for displaying program information in a banner

(76) Inventor: Johannes Cornelius Maria Van Beek, Gilze (NL)

Correspondence Address: Phillips Electronics North America Corporation, Corporate Patent Counsel, PO Box 3001, Briarcliff Manor, NY, 10510, US

(21) Appl. No.: 10/485,763

(22) PCT Filed: Aug. 2, 2002
(86) PCT No.: PCT/IB02/03250

(30) Foreign Application Priority Data
Aug. 6, 2001 (EP) 01202963.3

(51) Int. Cl. H04N 7/025; H04N 5/445; G06F 3/00; H04N 7/10

(52) U.S. Cl. 725/42; 348/563; 725/32; 725/43

(57) ABSTRACT

When program information is displayed in a banner on a screen (31), a longitudinal direction of a banner (9, . . . , 13, 20, 21, 44, 46) corresponds to time. Ends of a banner (9, . . . , 13, 20, 21, 44, 46) correspond to a start time and a finish time. The banner (9, . . . , 13, 20, 21, 44, 46) is made up of pixels and is displayed in the form of a 3D banner (20, 21) by starting the banner (20, 21), seen in the longitudinal direction, with a starting area (14) having a predetermined starting dimension and finishing the banner with a end area (15) having a predetermined end dimension. An intermediate area (16) is located between a starting area (14) and an end area (15). The starting (14) and end (15) areas are discernibly different from the intermediate area (16) on the screen (31). In the case of a screen (31) display in which one or more pixels (6) of a first banner (9, . . . , 13, 20, 21, 44, 46) coincide with one or more pixels (6) of a second banner (9, . . . , 13, 20, 21, 44, 46), either the number of pixels of at least one of the banners (9, . . . , 13, 20, 21, 44, 46) is reduced by maximally the number of coinciding pixels (6) or one of the banners (9, . . . , 13, 20, 21, 44, 46) is displayed in a non-discernible manner, or not at all.

The invention relates to a method of displaying program information in a banner on a screen, in which method a longitudinal direction of a banner corresponds to time and ends of a banner correspond to a start time and a finish time.

The invention furthermore relates to an apparatus for carrying out such a method, which apparatus comprises means for displaying program information in a banner on a screen.

Such a method and apparatus are known from U.S. Pat. No. 6,057,890. The displaying of program information in a banner on a screen is a form of EPG, which letters stand for Electronic Program Guide. A part of the day is displayed on a strip for each broadcasting station or channel. A program with start and finish times is displayed in the form of a banner and takes up part of the strip.

One drawback of the known method and apparatus is the fact that it is difficult to indicate precisely at what time a particular program will begin and at what time a particular program will end. Furthermore it is disadvantageous that several parts of the banner are displayed “flat” with the method and apparatus according to the aforesaid US patent, as a result of which various parts of the banner are precisely contiguous to each other, seen in the longitudinal direction, making it difficult to distinguish where one part of the banner ends and where the next part of the banner starts. Another drawback of the known method and apparatus is the fact that it is not indicated how to deal with (partially or completely) overlapping banners.

The object of the invention is to provide a method and an apparatus which make it easier to distinguish various parts of a strip, in which start times and finish times can be visualized with greater precision and in which a solution is provided for the problem of overlap of information to be displayed in banners on a strip.

With a method according to the invention, this object is achieved in that the banner is displayed in the form of a 3D banner which is realized by starting the banner, seen in the longitudinal direction, with a starting area having a predetermined starting dimension and finishing the banner with an end area having a predetermined end dimension, which starting and end areas are discernibly different on the screen from the intermediate area that is located therebetween, and in that in the case of a screen display in which one or more pixels of a first banner coincide with one or more pixels of a second banner either the number of pixels of one of the banners is reduced by maximally the number of coinciding pixels or one of the banners is displayed in a non-discernible manner, or not at all.

As a result, a banner showing a program with start and finish times is given a 3D appearance as a result of the provision of said starting and end areas. It has become apparent that 3D display significantly improves the discernibleness of successive banners on the viewing screen. Another result is that if pixels of the banners of, for example, two successive programs coincide, the length of the banners will be changed in such a manner that a display is obtained which best suits the users' expectations and requirements.

The present invention is based on the insight that it must be possible to distinguish between three different types of events that can be represented in a banner. The first type of events are normal events which occur as part of the broadcasting schedule of a particular broadcasting station or a particular channel. The second type of events are empty events, which term is understood to mean times at which no information as regards content of a program that may be broadcast is present, or that there is no program about which information can be broadcast. Such empty events thus fill the gaps between normal events. The third type of events are “loading information” events, which likewise do not occur by themselves within the schedule of programs to be broadcast. Loading information events only take place if a schedule has not been received completely yet. Loading information events only exist during the time that no schedule information has been received, and consequently they are virtual events that fill any gaps that may be present.

In an EPG, the user can navigate through all events by means of the up-down, left-right arrows on the remote control device. The user receives feedback on the type of event that has been selected on the basis of the color or the content of the event. Normal events include the “name” of the event in question. Empty events, on the other hand, do not have a name. Empty events may have the same color as the background color of the EPG, so that they are not discernable. Within the framework of the present invention, however, such empty events may also be displayed in the form of a 3D banner, so that the user will more easily recognize that normal events are not present at those points in time.

A loading information event can be indicated as such by a name in the EPG. For example, the indication “loading information from satellite” or the like may be used. A loading information event is likewise displayed in the form of a 3D banner on the screen, its color may differ from the color that is used for normal events. As soon as loading information is complete, the indication in question will be substituted for the name and possibly the color of the normal event in question.

Accordingly, a preferred version of a method according to the invention is characterized in that one of several types of information is displayed in a banner.

As a result, the user can see various types of information in a banner, such as the fact whether the banner represents a normal event, an empty event or a loading information event.

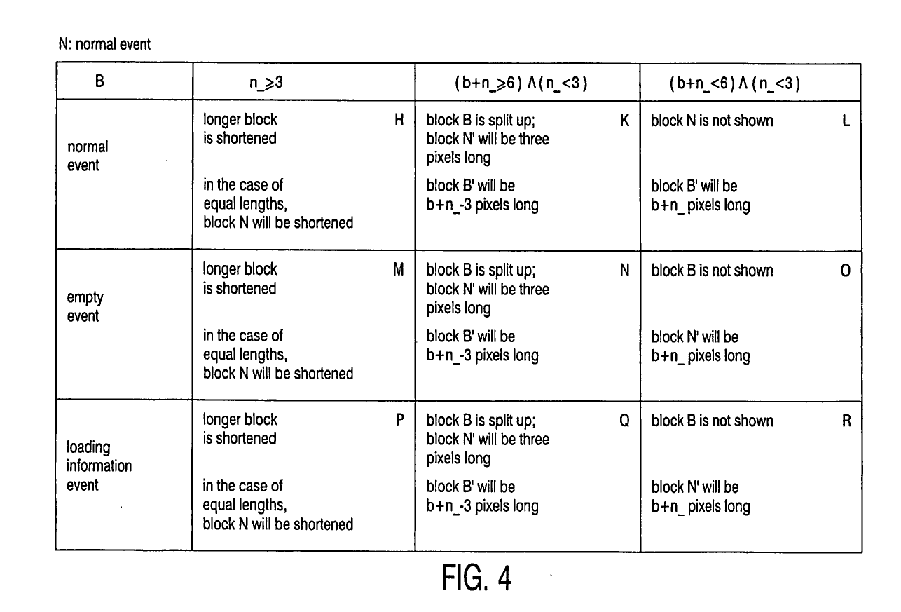

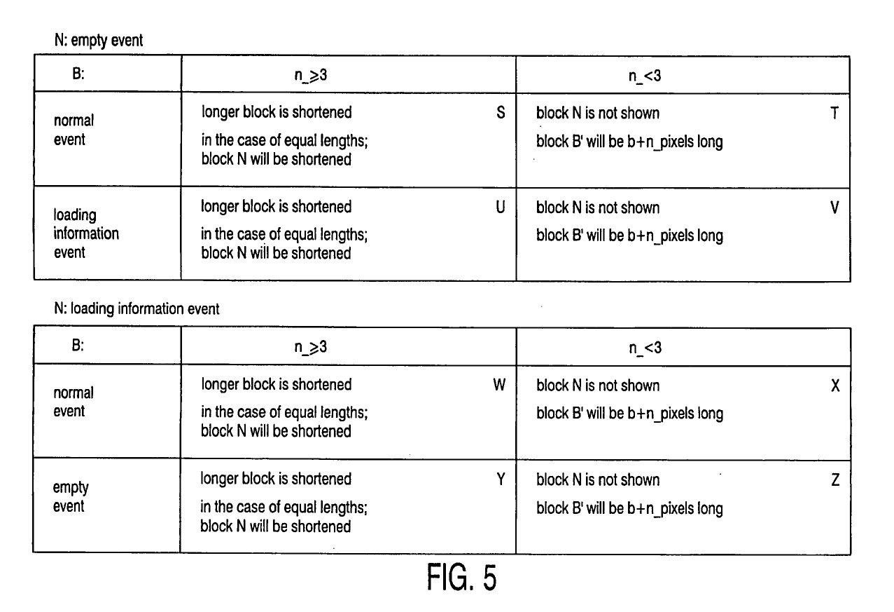

Another preferred version of a method according to the invention is characterized in that the manner in which the coinciding portion of two banners is displayed is determined in accordance with the algorithm that is shown in FIGS. 4 and 5.

A preferred version of an apparatus according to the invention is characterized in that the look-up the table is based on the algorithm that is shown in FIGS. 4 and 5.

As a result, events which take up two pixels, or fewer, seen in the longitudinal direction of a banner, will or will not be displayed in the form of a 3D banner, depending on the significance they represent, and another banner with which they coincide in part will either be reduced in length or extended. The reduction of the length of one banner takes place in order to be able to display the other banner in the form of a 3D banner.

The invention will now be explained in more detail with reference to the accompanying drawings, in which:

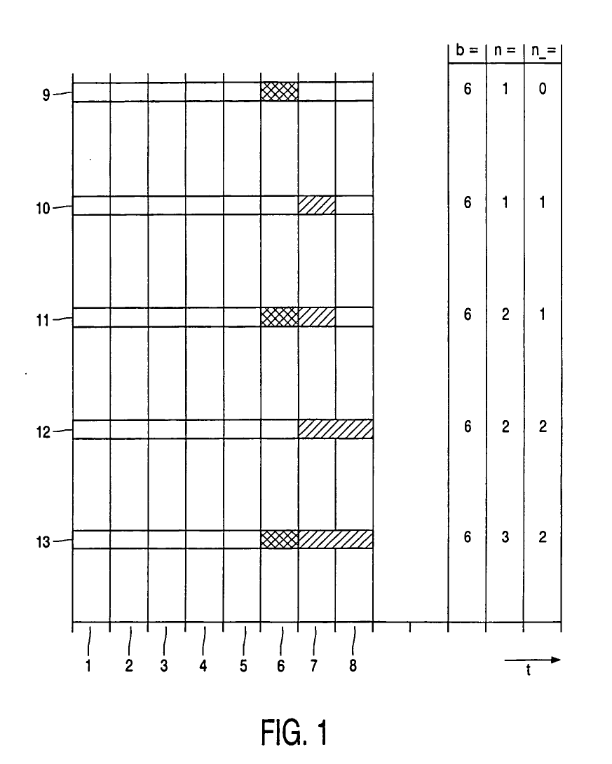

FIG. 1 is a diagrammatic representation of a time line divided into pixels, showing two banner of which some pixels coincide in certain cases;

FIG. 2 shows the minimally required number of pixels for a 3D display;

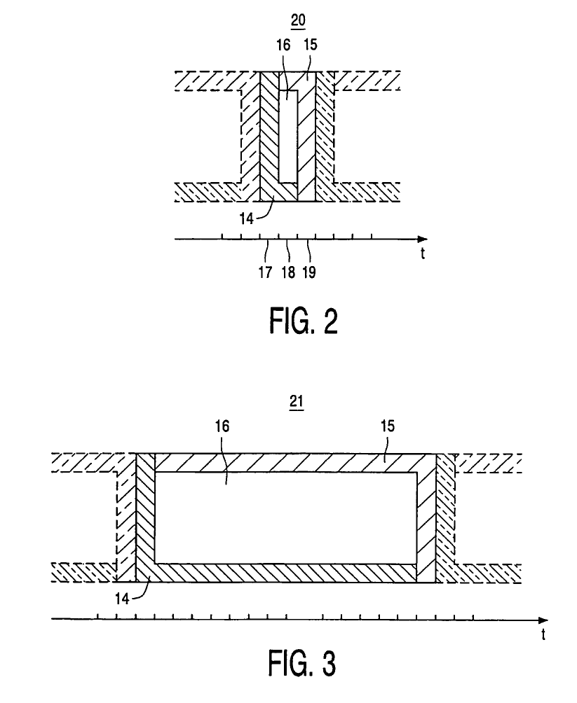

FIG. 3 shows a general example of a 3D banner;

FIG. 4 shows a first part of an algorithm for representing two events having coinciding pixels;

FIG. 5 shows the second part of the algorithm for displaying two events having coinciding pixels;

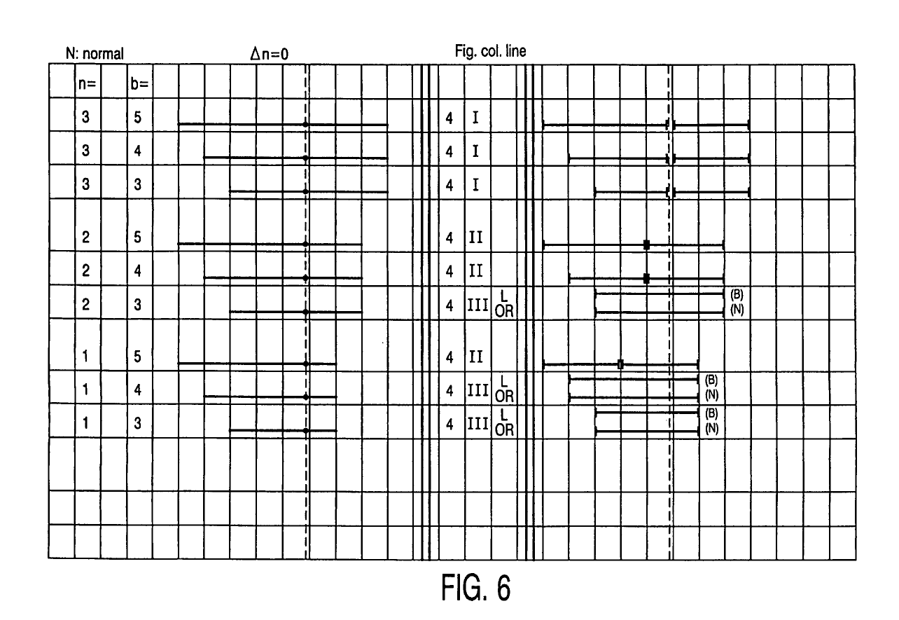

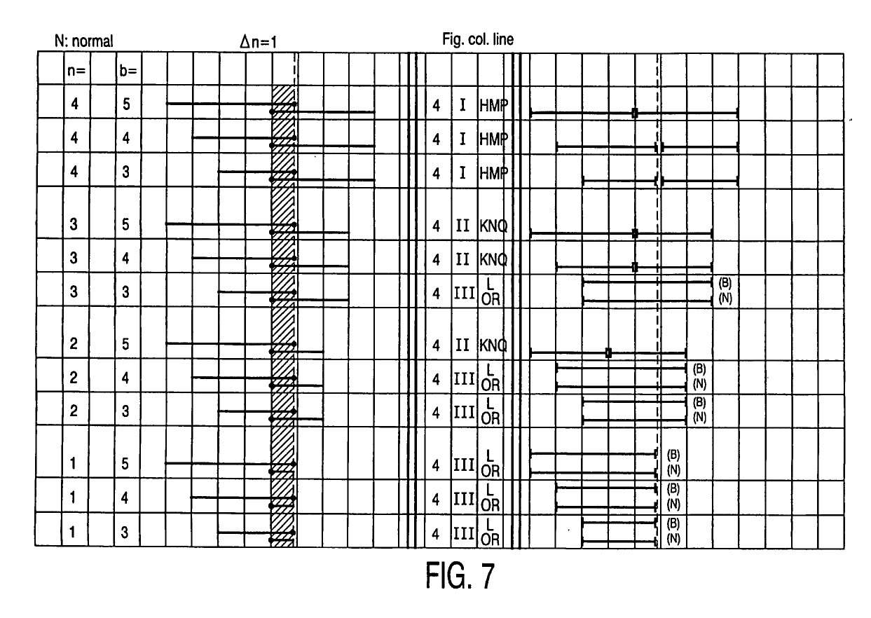

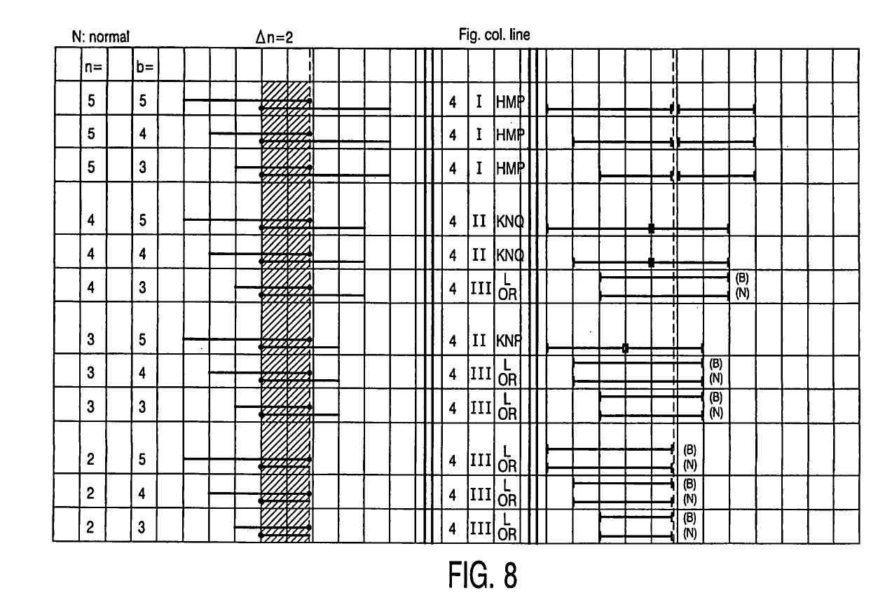

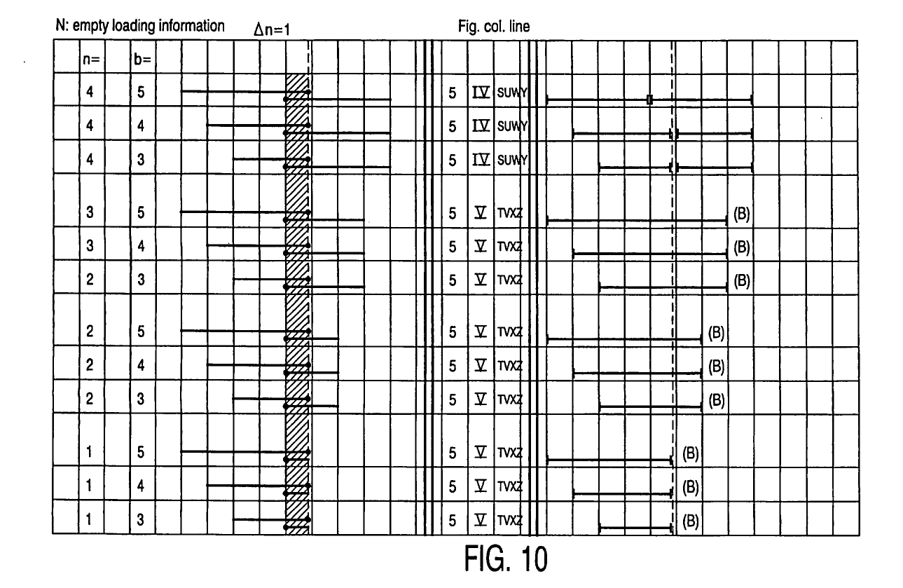

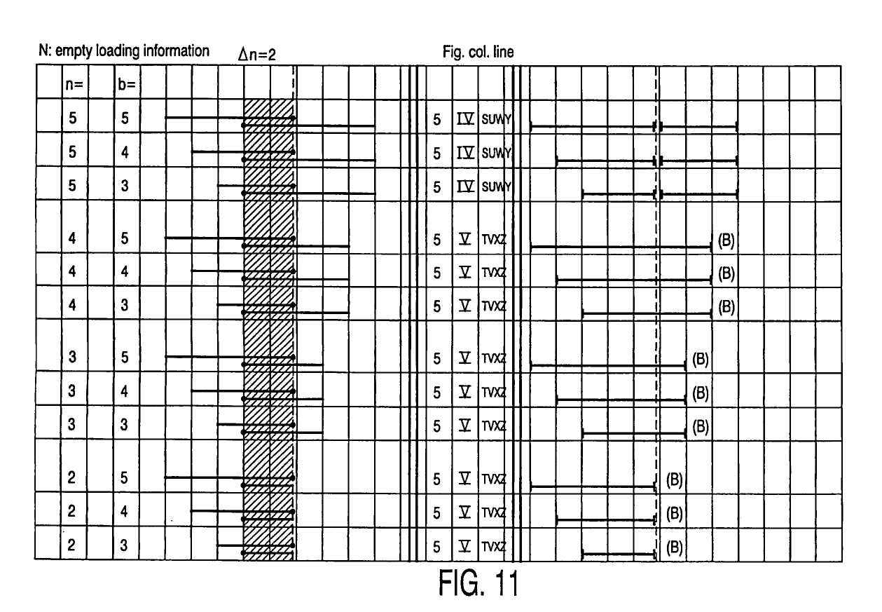

FIGS. 6 to 11 are graphic representations of the application of the algorithm according to FIG. 4 and FIG. 5; and

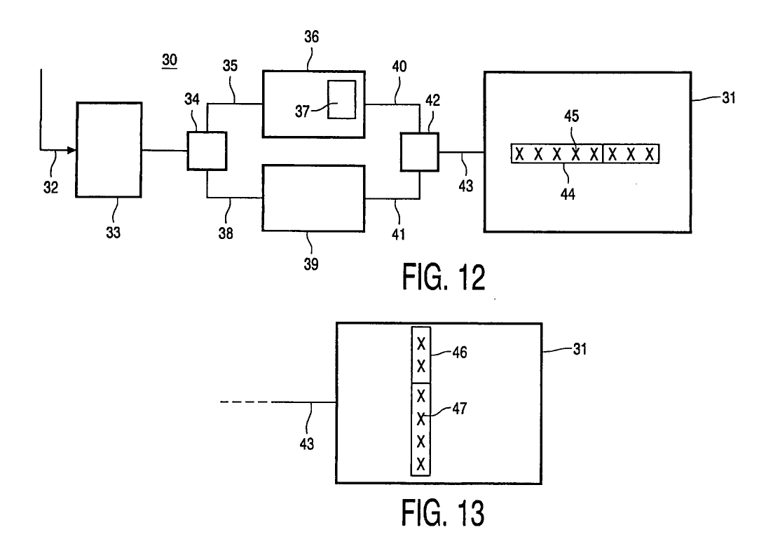

FIG. 12 is a diagrammatic representation of an apparatus provided with means for displaying an EPG; and

FIG. 13 shows an alternative form of displaying an EPG.

Before entering into a detailed discussion of FIGS. 1 to 13, first a few definitions will be given with regard to terms to be used in the description of the figures and in the figures themselves. The term “event” relates to a coherent (in time) entity which can be displayed on the screen as one banner with a start time and a finish time. Hereinafter, a distinction will be made between an event B and an event N. It is important in this connection that the event B has a start time which precedes the start time of the event N. If the two events should have the same start time, event B is understood to mean that event which lasts longer than the event which has the same start time but which lasts less long. The term “pixel” is understood to mean an area on the viewing screen in which, seen in the longitudinal direction of a banner, a defined structure is not present any more, i.e. the shortest possible discernable period of time that is represented on the screen. It is noted in this connection that, consequently the word pixel in this sense does not relate to the spatial resolution of the viewing screen itself or to a time resolution of the electric or electromagnetic signal being represented in the form of a banner. The designations “block B” and “block N” indicate the block of pixels or the banner of pixels having the length of the event B and the event N, respectively. The designations “b” and “n” are used to indicate the length, expressed in pixels, of the events B and N, respectively. The designations “l_{b}” and “lₙ” indicate the length in time, expressed in pixels, of the representation of the block B and the block N, respectively, as obtained from the algorithm yet to be discussed in more detail hereinafter. “Δn” indicates the number of pixels by which the block N coincides with the block B. The designation “n_” indicates the number of pixels of block N that do not coincide with pixels of the block B. It is noted that n_=n−Δn. Furthermore it is noted that in accordance with the preceding definitions, l_{b}+lₙ=b+n−Δn. “Block B” and “block N” finally indicate the block B′ and the block N′, respectively, also called the banner B′ and the banner N′, respectively, having the duration l_{b} and lₙ, respectively, of the display of the respective events B and N after application of the algorithm yet to be discussed in more detail hereinafter.

At the bottom of FIG. 1, a time bar comprising time spans 1 to 8 is shown. Also shown in FIG. 1 are five possibilities 9 to 13 of representations of two events B and N in the form of banners on a viewing screen having a longitudinal direction corresponding to time. It has been assumed that the event B has a length b, expressed in pixels, of six pixels (rounded off) and that the event N has a length of one pixel (rounded off) in representations 9 and 10, two pixels in representations 11 and 12 and three pixels in representation 13. The representations 9 to 13 all start at the beginning of pixel 1. Consequently, the end of the block B will coincide with the end of the pixel 6 at all times. The event N follows on the event B. Because of the rounding, the block N coincides with the block B in the representation 9 as indicated by the crosshatching in the pixels 6 of the representation 9. In the representation 10, the block N falls outside the time span of the block B because of said rounding. Similar situations are shown in the representations 11 and 12, in each of which the block B has a length of six pixels and the block N has a length of two pixels. The representation 13 finally shows the situation in which the block B has a length of six pixels the block N has a length of three pixels and the block B and the block N coincide in the pixel 6. In the columns shown beside the representations 9 to 13, the values for b, n and n_ for each of the representations 9 to 13 are shown in a first column.

It is noted that the coincidence of portions of banners in FIG. 1 is shown to be caused by rounding off, as is the case, for example, if one pixel represents a time interval of five minutes, whilst the accuracy of the start and finish times is one minute. Such situations can easily occur if a considerable number of hours of one day must be displayed simultaneously on a viewing screen.

It is also noted that in some cases events, which are individual programs, are not fully fixed in advance both as regards their content and as regards their start and finish times. Such a situation occurs, for example, if the preceding program is a sports match, in which the start time may be fixed in advance but the finish time is not, as is the case with a tennis match, for example. Furthermore, a situation may occur in which it is not known in advance whether the particular event, such as a sports match, will be broadcast. In such a situation blocks of sizeable dimensions will coincide; one block will then relate to one programming possibility at a particular point in time represented by a pixel, whilst a block coinciding therewith on the pixel in question will contain the alternative programming possibility.

As is shown in FIG. 1, the two blocks B and N cannot be correctly displayed simultaneously in the representations 9, 11 and 13. The algorithm that is to be explained in more detail hereinafter will provide a solution for this problem. Part of the solution for representing blocks in a more easily discernible manner on the screen is the use of so-termed highlights and shadows for the purpose of obtaining a 3D effect. Seen in the direction of time, the use of a 3D display makes it necessary for the minimum duration of a representation of a block to equal three pixels. Refer to FIG. 2 in this connection. One pixel is required for displaying the shadow 14, one pixel for displaying the highlight 15 and one pixel for displaying the program represented by the block. The smallest possible block 20 of FIG. 2, therefore, comprises three pixels 17, 18 and 19.

Although the smallest possible representation of the block thus comprises three pixels, situations occur in which the length in time of an event is so small that the start time and the finish time fall within two pixels, in some cases even within one pixel. A solution must be found for such situations.

FIG. 3 shows a block 21, which is normal by itself and comprises a shadow edge 14 and a highlight edge 15 and an intermediate area 16. The pixel dimension of the shadow edge 14, the starting area of the block or bar 21, is shown to have a width of one pixel in FIG. 3. Other pixel widths are also feasible, of course. The same holds with regard to the length in time, expressed in pixels, of the highlight 15. Present between the shadow edge 14 and the highlight edge 15 is the intermediate area 16. Information relating to the program that is represented by the block 21 can be displayed in said intermediate area 16.

In practice it has become apparent that three kinds of events represented by a block 21 can be distinguished. The first kind are normal events. Normal events are events which occur in the schedule of programs to be broadcast. The second kind are empty events. The empty events are events are without content that occur between normal events. An empty event, for example, is a period during the night in which a broadcasting station does not broadcast any programs. Finally, there are “loading information” events. These events do not occur in the normal schedule either. The loading of information takes place during that time span in which a schedule from a broadcasting station is received. In that time span, therefore, information on the program cannot be displayed on the screen yet.

Normal events and empty events as well as loading information events are displayed on the screen in 3D. As already mentioned with reference to FIG. 2, the minimum number of pixels required for displaying an event equals three, that is, even if the length in time of such an event only comprises one or two pixels.

Furthermore, situations may occur in which an event of short duration, for example a duration of one, two or three pixels, partially coincides with another event. The blocks in question will overlap in that case, for example, as is apparent from FIG. 1, for example. The display problem is made worse not only if there is an overlap but also if at least one of the two blocks to be represented comprises a time span which equals three pixels or less.

FIGS. 4 and 5 show an algorithm by means of which it is possible to determine, for any combination of events and lengths in time of the events that may occur, how the combination of the events in question will be represented on the screen. The algorithm that is shown in FIGS. 4 and 5 concerns two events which do not have the same start time and which either precisely follow on each other or coincide to a certain extent. The event having the earliest start time is called event B. The event having the later start time is called event N.

Referring to the above definitions of various kinds of events, seven different combinations of events are conceivable. The combination of event B is an empty event and event N is an empty event in fact means that there is only one empty event which starts at the start time of the event B and ends at the finish time of the event B. It has been assumed in this connection that the event N does not completely fall within the time span of the event B. Nor does it occur in practice that the event B is a loading information event and the event N is a loading information event as well. Such a combination will also merge into one loading information event.

In order to obtain a correct 3D display on the screen, the algorithm that is shown in FIGS. 4 and 5 must be followed precisely. It should be considered in that connection that if it should be possible to represent the event B and the event N in accordance with the algorithm as shown in FIGS. 4 and 5 in more than one way, the representation in which the block B′ is the larger block will be taken.

The results of the application of the algorithm of FIGS. 4 and 5 is graphically represented in FIGS. 6 to 11. In particular, only those cases are shown in which the number of non-overlapping pixels is three or less. If the number of non-overlapping pixels is greater than three, the longest block will be shortened in all cases, whilst the block N will be shortened if the blocks have the same length.

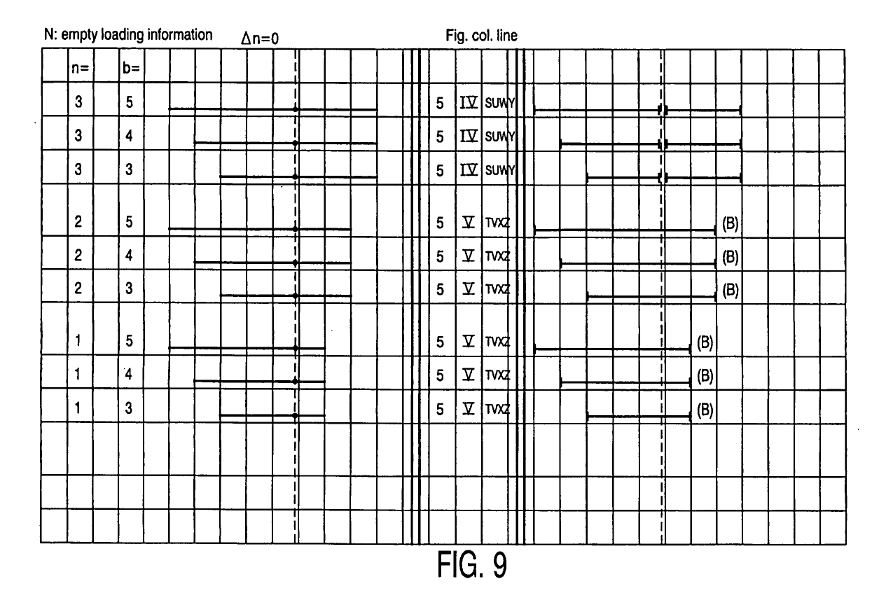

FIGS. 6, 7 and 8 are graphic representations of the situation in which the event N is a normal event and the overlap An equals zero, one and two pixels, respectively. FIGS. 9, 10 and 11 are graphic representations of the situation in which the event N is an empty event or a loading information event, that is, again for a number of overlapping pixels Δn=0, 1 and 2, respectively.

In each of the FIGS. 6 to 11, the length in time of the events N and B, expressed in a number of pixels n and b, respectively, is indicated in the extreme left columns. The next graphic column shows which pixels, one pixel being the space between two vertical lines, are taken up by the events B and N. The vertical dotted lines indicate the respective ends of the pixel in which the event B ends. The hatching indicates the pixel or pixels taken up both by the event B and by the event N. In the center of each of the FIGS. 6 to 11 three columns are present between the vertical double lines. The left-hand column indicates which of the FIGS. 4 and 5 applies with regard to the situation as shown, the central column indicates which of the columns in FIGS. 4 and 5 applies to the situation as shown, and the right-hand column indicates which of the rectangles in the respective column applies in the figure in question. The right half of FIGS. 6 to 11 shows the graphic representation of the pixels on the screen. The vertical dotted line again indicates the end of the pixel comprising the end of the event B. The horizontal line through a pixel indicates that the pixel in question represents the event in question. The vertical ends on the horizontal lines indicate that the horizontal line in question begins and ends, respectively, with the pixel in question. If two successive horizontal lines are shown on one line, the left-hand line indicates the block B′, i.e. the pixels that represent the event B after application of the algorithm, and the right-hand line indicates the block N′, i.e. the pixels that represent the event N after application of the algorithm. If only one long horizontal line having one vertical end on the left and one vertical end on the right is shown on the line, the letter between brackets at the right-hand end thereof indicates which event is represented by the pixels in question.

FIG. 12 shows a television receiving device 30 with a viewing screen 31. The receiving device 30 comprises a signal input 32 for a tuning unit 33. One output of the tuning unit 33 is connected to the splitting device 34. A first output 35 of the splitting device 34 is connected to a “grid EPG” device 36 which comprises a look-up table 37. A second output 38 of the splitting device 34 is connected to a signal processing device 39 which decodes image signals from the signal on the input 32 that has been selected via the tuning unit 33. An output 40 of the device 36 and an output 41 of the device 39 are each connected to corresponding inputs of a combining device 42. The combining device 42 combines the output signals from the devices 36 and 39 into a combined signal which is suitable for display on the viewing screen 31. To that end, the combining device 42 is connected to the viewing screen 31 via a line 43. The operation of the device 30 is as follows.

Via the input 32, a television signal enters the device 30, which signal is selected by means of the tuning unit 33. The television signal in question comprises so-termed “grid EPG” information which makes it possible to display program information in a banner on a viewing screen, such as the viewing screen 31. The output signal from the tuning unit 33 is separated by the splitting device 34 into a signal with image information which is available on the output 38 and a signal with grid EPG information on the output 35. The device 36 processes the grid EPG information into a signal which can be displayed in a banner on the viewing screen 31. The look-up table 37 comprises, in a manner which is known per se, a suitable electronic form of the algorithm that is shown in FIGS. 4 and 5 and causes a signal to appear on the output 40, this signal, upon display on the viewing screen 31, corresponds to the blocks B′ and X, that is, as shown in the extreme right graphic column in FIGS. 6 to 11.

FIG. 13 shows an alternative way of displaying the banners. In this example, vertical banners are used. This system may be preferable in countries in which text is displayed in vertical columns, from top to bottom rather than in horizontal columns from left to right or from right to left.

All kinds of embodiments and modifications will be apparent to a person skilled in the art who has read the foregoing. All such modifications and embodiments are considered to fall within the scope of the invention.

1. A method of displaying program information (45, 47) in a banner (9, . . . , 13, 20, 21, 44, 46) on a viewing screen (31), in which method a longitudinal direction of a banner (9, . . . , 13, 20, 21) corresponds to time (t) and ends of a banner (9, . . . , 13, 20, 21, 44, 46) correspond to a start time and a finish time, characterized in that the banner (9, . . . , 13, 20, 21, 44, 46) is built up of pixels, that the banner (9, . . . , 13, 20, 21, 44, 46) is displayed in the form of a 3D banner (20, 21), which is realized by starting the banner (20, 21), seen in the longitudinal direction, with a starting area (14) having a predetermined starting dimension and finishing the banner with a end area (15) having a predetermined end dimension, an intermediate area (16) being situated between a starting area and an end area, which starting (14) and end (15) areas are discernibly different on the screen (31) from the intermediate area (16) that is located therebetween, and in that in the case of a screen (31) display in which one or more pixels (6) of a first banner (9, . . . , 13, 20, 21, 44, 46) coincide with one or more pixels (6) of a second banner (9, . . . , 13, 20, 21, 44, 46) either the number of pixels of at least one of the banners (9, . . . , 13, 20, 21, 44, 46) is reduced by maximally the number of coinciding pixels (6) or one of the banners (9, . . . , 13, 20, 21, 44, 46) is displayed in a non-discernible manner, or not at all.

2. A method as claimed in claim 1, characterized in that one type of several types of information (45, 47) is displayed in a banner (9, . . . , 13, 20, 21, 44, 46).

3. A method as claimed in claim 2, characterized in that the manner in which the coinciding portion (6) of two banners (9, . . . , 13, 20, 21, 44, 46) is displayed depends both on the degree of coincidence and on the type of information (45, 47) to be displayed in each of the two banners (9, . . . , 13, 20, 21, 44, 46).

4. A method as claimed in any one of the claims 1 to 3, characterized in that the manner in which the coinciding portion (6) of two banners (9, . . . , 13, 20, 21, 44, 46) is displayed depends on which of the two banners (9, . . . , 13, 20, 21, 44, 46) has the earlier start time.

5. A method as claimed in one of the claims 1 to 4, characterized in that the manner in which the coinciding portion of two banners (9, . . . , 13, 20, 21, 44, 46) is displayed is determined in accordance with the algorithm that is shown in FIGS. 4 and 5.

6. A method as claimed in one of the claims 1 to 5, characterized in that the predetermined starting and end dimensions equal an integer number of pixels (14, 15) of the banner (20, 21).

7. An apparatus for carrying out the method as claimed in claim 1, comprising means (36) displaying program information (45, 47) in a banner (9, . . . , 13, 20, 21, 44, 46) on a viewing screen (31), characterized in that means (36, 42) are present for building up the banner (9, . . . , 13, 20, 21) by means of pixels and displaying it as a 3D banner (20, 21) having a starting area (14) of a predetermined starting dimension, an intermediate area (16) and an end area (15) of a predetermined end dimension, which starting (14) and end (15) areas are discernibly different on the screen (31) from the intermediate area (16) of the banner, and in that there is provided a look-up table (37) which specifies, in the case that pixels (6) of a first banner (9, . . . , 13, 20, 21, 44, 46) coincide with pixels (6) of a second banner (9, . . . , 13, 20, 21, 44, 46), which banner (9, . . . , 13, 20, 21, 44, 46) will or will not be displayed and in which manner.

8. An apparatus as claimed in claim 7, characterized in that means (36) are provided whereby, in addition to program information (45, 47), at least one different type of information (45, 47) can be displayed in a banner (9, . . . , 13, 20, 21, 44, 46).

9. An apparatus as claimed in claim 8, characterized in that a display mode stored in the look-up table (37) depends both on the degree of coincidence and on the type of information (45, 47) to be displayed in each of the two banners (9, . . . , 13, 20, 21, 44, 46).

10. An apparatus as claimed in claim 8 or 9, characterized in that the number of types of information (45, 47) is three.

11. An apparatus as claimed in claim 7, 8, 9 or 10, characterized in that the look-up table (37) is based on the algorithm that is shown in FIGS. 4 and 5.

12. An apparatus as claimed in any one of the claims 6-11, characterized in that the predetermined starting and end dimensions equal an integer number of pixels (14, 15).
